(19) United States
(12) Patent Application Publication
(10) Pub. No.: US 2016/0102208 A1
(43) Pub. Date: Apr. 14, 2016

(54) WATER-SOLUBLE AZO COMPOUND OR SALT THEREOF, INK COMPOSITION, AND COLORED ARTICLE

(71) Applicant: NIPPON KAYAKU KABUSHIKI KAISHA, Tokyo (JP)

(72) Inventors: Rie TAKEUCHI, Tokyo (JP); Mariko UMEDA, Tokyo (JP)

(21) Appl. No.: 14/893,239

(22) PCT Filed: May 30, 2014
(86) PCT No.: PCT/JP2014/064486

§ 371 Date: Nov. 23, 2015

(30) Foreign Application Priority Data
May 31, 2013 (JP) 2013-115407
May 31, 2013 (JP) 2013-115408

(51) Int. Cl. C09B 43/11; C09D 11/328

(52) U.S. Cl. CPC C09B 43/11; C09D 11/328

(57) ABSTRACT

A water-soluble azo compound represented by formula (1) or a salt thereof. The water-soluble yellow dye (compound) has high solubility in water, and excellent fastness properties including water resistance, moisture resistance, ozone gas resistance, scratch resistance and light resistance, and has superior color-developing properties (printing density) and color saturation. A yellow ink composition which contains the yellow dye is used for various recording purposes, particularly inkjet recording purposes. In formula (1), Q represents a halogen atom; x represents an integer of 2 to 4; and Y represents a group represented by formula (A) or (B). In formula (B), n represents an integer of 1 to 4; and R represents a hydrogen atom, a sulfo group or a carboxy group.

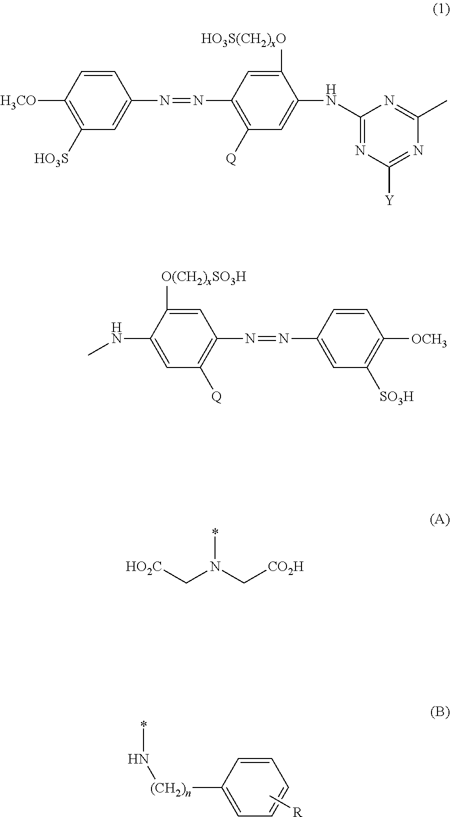

### TECHNICAL FIELD

The present invention relates to a water-soluble azo compound or a salt thereof, an ink composition containing the above compound and a colored article colored by these.

### BACKGROUND ART

Various ink discharging systems have been developed for a method of recording with an ink-jet printer, which is one of representative methods of various color recording methods. These systems all involve generating a droplet of ink, which is then allowed to attach to various recording materials (paper, film, textile and the like), thereby performing recording. This method is quiet since a recording head does not make direct contact with a recording material, generating no sound. Further, these systems, which can easily be downsized, accelerated, and adapted to full-color, are becoming increasingly popular in recent years, and significant and continuous growth is expected.

Conventionally, inks in which a water-soluble pigment (dye) is dissolved in an aqueous medium are used as those for fountain pens, felt-tip pens and the like and for ink-jet recording. In general, a water-soluble organic solvent is added to these water-based inks in order to prevent ink clogging in a pen nib and an ink discharge nozzle. The following characteristics are required for these inks: giving recorded images with a sufficient density; not causing clogging of a pen nib or a nozzle; good drying property on a recording material; less significant bleeding; and superior storage stability.

A clogging of an ink-jet nozzle is often caused by solidification and precipitation of a pigment when water in the ink evaporates before other solvents and additives near the nozzle, resulting in a composition where less water, and more solvents and additives are present. Therefore, one of the very important required performances is prevention of precipitation of a solid even in a state where a water content of an ink is decreased. For this reason, a high solubility in a solvent or an additive is also one of the properties required for pigments. Alternatively, use of a pigment with a high printing density is known as an approach for solving the nozzle clogging. The use of a pigment with a high printing density can maintain a conventional printing density while reducing the pigment content of the ink. This is advantageous not only in prevention of precipitation of a pigment but also in terms of cost. Therefore, the development of a pigment with a high printing density has been demanded.

Meanwhile, in order to record an image or a text on a color computer display in full-color with an ink-jet printer, the subtractive color mixing is used with four color inks of yellow (Y), magenta (M), cyan (C) and black (K), thereby presenting a recorded image in color. In order to reproduce an image on a CRT (cathode-ray tube) display and the like created by the additive color mixture method with red (R), green (G) and blue (B) in a format of the subtractive color mixture as faithfully as possible, each pigment used for an ink, in particular each of Y, M and C, is desired to be vivid, and to have a hue close to the standard color. In general, vividness used herein means having high color saturation. In a case where the three primary colors of Y, M and C with low color saturation, the color region which can be expressed in a single color or a color mixture may be narrow, resulting in an insufficient range of the color region to be expressed. Therefore, development of a pigment with high color saturation and an ink containing the same is demanded.

Furthermore, the following characteristics are required for an ink: stability over long-term storage; high density recorded images; and the resulting images superior in fastness such as water resistance, moisture resistance, light resistance and gas resistance.

As used herein, gas resistance refers to a resistance against a phenomenon that a gas in the air having an oxidizing effect (also referred to as an oxidizing gas) reacts with a pigment (dye) in a recorded image on or inside a recording material, resulting in discoloring of the recorded image. Among oxidizing gases, ozone gas, in particular, is considered as a major substance responsible for promoting the discoloring phenomenon of an ink-jet recorded image. Since this discoloring phenomenon is characteristic of an ink-jet recorded image, the improvement in ozone gas resistance is an important technical challenge in the art.

Recent development in the ink-jet technology remarkably improves the speed of ink-jet recording (printing). Accordingly, there is a tendency of the market to use an ink-jet printer for printing documents on regular paper, which is a major purpose of a printer in the office environment, in a similar way to a laser printer where an electronic toner is used. Advantageously, ink-jet printers can work with any type of recording paper, and are inexpensive, and thus they are becoming increasingly popular, in particular, in small to medium sized office environments such as small offices and home offices (SOHO). When ink-jet printers are used for the purpose of printing on regular paper as described above, hue, color-developing (printing) density and water resistance tend to be more crucial among other characteristics required for printed matters.

Methods of using a pigment ink have been proposed in order to satisfy these required characteristics. However, a pigment ink does not produce a solution state but produces a dispersed state because a pigment does not dissolve in a water-based ink. Therefore, when a pigment ink is used for ink-jet recording, problems may arise such as stability of the ink itself and clogging of a nozzle of a recording head and the like. Furthermore, use of the pigment ink often leads to the problem in abrasion resistance. In a case of a dye ink, these problems are supposed to arise relatively less often. However, a dye ink is significantly inferior to the pigment ink particularly in water resistance, and thus an improvement in water resistance has been strongly desired. Furthermore, unlike the pigment ink, with the dye ink, a pigment attached on a surface of regular paper by ink-jet recording penetrates more rapidly toward the back of paper, often resulting in the problem of decreased color-developing density.

One of the methods for obtaining a photographic quality ink-jet recorded image is to provide an ink receiving layer on a surface of a recording material. The ink receiving layer provided for this purpose often contains a porous white inorganic substance in order to achieve rapid drying of an ink, and to reduce the bleeding of a pigment at high definition. However, significant discoloration due to the aforementioned ozone gas is seen particularly for such a recording material. As digital cameras and color printers have been becoming popular in recent years, there are increasing demands for printing images taken with digital cameras and the like in photograph quality at home. Therefore, discoloration of recorded images due to the aforementioned oxidizing gas is considered as a problem. As a yellow pigment, one having light resistance as well as a superior resistance to an oxidizing gas has been proposed, as compared with the other two of the three primary colors, magenta and cyan. However, a yellow pigment or a yellow ink for ink-jet recording that sufficiently satisfies high vividness and various types of fastness required by the market has not yet be obtained.

Known yellow pigments for ink-jet with excellent water solubility and vividness include C.I. (Color Index) Direct Yellow 132. Patent Documents 1 to 3 disclose examples in which C.I. (Color Index) Direct Yellow 132 is used for ink-jet. Furthermore, Patent Document 4 discloses a yellow pigment for ink-jet having superior ozone gas resistance.

Patent Document 1: Japanese Unexamined Patent Application, Publication No. H11-70729

Patent Document 2: Japanese Patent No. 3346755

Patent Document 3: Japanese Patent No. 4100880

Patent Document 4: PCT International Publication No. WO2010/125903

### DISCLOSURE OF THE INVENTION

### Problems to be Solved by the Invention

An objective of the present invention is to provide a water-soluble yellow pigment (compound) producing recorded images with excellent color-developing properties (printing density) and excellent color saturation, and a yellow ink composition containing the above water-soluble yellow pigment (compound) for various recording purposes, in particular for an ink-jet recording purpose.

### Means for Solving the Problems

After conducting extensive studies to solve the above described problems, the present inventors have found that a specific water-soluble azo compound represented by the following formula and an ink composition containing the above compound can solve the above problems, leading to the completion of the present invention.

That is, the present invention relates to the following 1) to 15).

1) A water-soluble azo compound represented by the following formula (1) or a salt thereof.

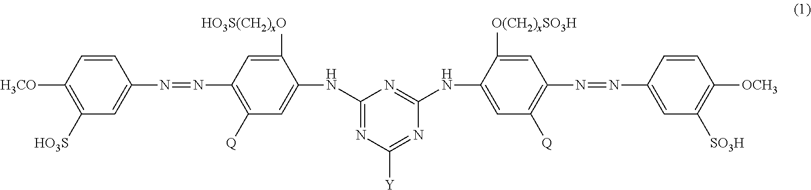

(In the formula (1), Q represents a halogen atom, and x represents an integer of 2 to 4, and Y represents a group represented by the following formula (A) or (B).)

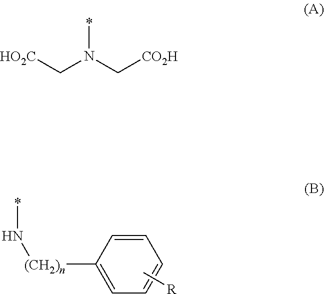

(In the formula (B), n represents an integer of 1 to 4, and R represents a hydrogen atom, a sulfo group or a carboxy group.)

2) The water-soluble azo compound or a salt thereof according to the above 1), wherein Q is a chlorine atom in the above formula (1).

3) The water-soluble azo compound or a salt thereof according to the above 1) or 2), wherein x is 3 in the above formula (1).

4) The water-soluble azo compound or a salt thereof according to the above 1), wherein Q is a chlorine atom, and x is 3, and Y is a group represented by the above formula (A) in the above formula (1).

5) The water-soluble azo compound or a salt thereof according to the above 1), wherein Q is a chlorine atom, and x is 3, and Y is a group represented by the above formula (B), and n is 1, and R is a sulfo group or a carboxy group in the above formula (1).

6) The water-soluble azo compound or a salt thereof according to the above 1), wherein Q is a chlorine atom, and x is 3, and Y is a group represented by the above formula (B), and n is 1, and R is a carboxy group in the above formula (1).

7) An ink composition containing the water-soluble azo compound or a salt thereof according to any one of the above 1) to 6).

8) The ink composition according to the above 7), further containing a water-soluble organic solvent.

9) The ink composition according to the above 7) or 8), which is intended for use in ink-jet recording.

10) An ink-jet recording method comprising of using the ink composition according to any one of the above 7) to 9) as an ink, and discharging an ink droplet of the ink to allow attachment to a recording material, thereby performing recording.

11) The ink-jet recording method according to claim 10, wherein the recording material is an information transmission sheet.

12) The ink-jet recording method according to the above 11), wherein the information transmission sheet is regular paper or a sheet having an ink receiving layer comprising a porous white inorganic substance.

13) A colored article colored with any of: (a) the water-soluble azo compound or a salt thereof according to any one of the above 1) to 6),

(b) an ink composition containing the water-soluble azo compound or a salt thereof any one of the above 1) to 6), or

(c) an ink composition containing the water-soluble azo compound or a salt thereof any one of the above 1) to 6) and a water-soluble organic solvent.

14) The colored article colored by the ink-jet recording method according to the above 10).

15) An ink-jet printer loaded with a container containing the ink composition according to the above 7).

### Effects of the Invention

The water-soluble azo compound according to the present invention represented by the above formula (1) or a salt thereof is characterized by high solubility in water, and superior filterability through, for example, a membrane filter in the course of manufacturing of the ink composition according to the present invention containing the above compound or a salt thereof. Furthermore, images recorded with the ink composition according to the present invention containing the compound according to the present invention are particularly excellent in printing density and color saturation as compared to those recorded with the conventional compounds. As described above, the water-soluble azo compound according to the present invention represented by the above formula (1) or a salt thereof, and the ink composition containing the above compound or a salt thereof are extremely useful in an ink application for various recording purposes, especially for an ink-jet recording purpose.

### PREFERRED MODE FOR CARRYING OUT THE INVENTION

The present invention will be described in detail.

The water-soluble azo compound according to the present invention represented by the above formula (1) or a salt thereof is a water-soluble yellow pigment. Unless otherwise specifically stated, acidic functional groups such as a sulfo group, a carboxy group are shown in a form of a free acid. The present invention encompasses both of the water-soluble azo compound represented by the above formula (1) and a salt of the aforementioned compound as described above. However, it is cumbersome to always refer to these as “the compound or a salt thereof.” For convenience, unless otherwise specifically stated, the term “the compound (water-soluble azo) according to the present invention or a salt thereof” may simply be referred to collectively as “the compound (water-soluble azo) according to the present invention” hereinafter.

The compound according to the present invention is represented by the above formula (1). In the above formula (1), Q represents a halogen atom, and x represents an integer of 2 to 4, and Y represents a group represented by the formula (A) or (B).

In the formula (1), Q represents a halogen atom. Specific examples of the halogen atom include a fluorine atom, a chlorine atom, a bromine atom and an iodine atom, and a fluorine atom or a chlorine atom is preferred, and a chlorine atom is particularly preferred.

In the above formula (1), x represents an integer of 2 to 4, and is preferably 3.

In the above formula (1), Y represents a group represented by the formula (A) or (B). In the above formula (B), n represents an integer of 1 to 4, and is preferably 1. Further, R represents a hydrogen atom, a sulfo group or a carboxy group, and is preferably a sulfo group or a carboxy group, and in particular preferably a carboxy group.

A compound of a combination of preferred ones among the above Q, x, n and R is more preferred, and a compound of a combination of more preferred ones among the above Q, x, n and R is even more preferred. The same applies to a combination of preferred one with more preferred one, etc.

For example, in a case where Y in the above formula (1) is a group represented by the above formula (A), a compound in which Q is a chlorine atom and x is 3 is particularly preferred.

In addition, in a case where Y in the above formula (1) is a group represented by the above formula (B), a compound in which Q is a chlorine atom, and x is 3, and n is 1, and R is a sulfo group or a carboxy group is particularly preferred, and a compound in which Q is a chlorine atom, and x is 3, and n is 1, and R is a carboxy group is most preferred.

For example, the compound according to the present invention represented by the above formula (1) can be manufactured as follows. It should be noted that Q, x, n and R which are appropriately used in the following formulae (2) to (7-B) each have the same meaning as in the formulae (1), (B).

A compound represented by the following formula (2) obtained in accordance with the method described in Japanese Unexamined Patent Application Publication No. 2004-75719 by using commercially available 2-amino-4-halogenophenol as a raw material is converted into a methyl-ω-sulfonic acid derivative represented by the following formula (3) using sodium bisulfite and formalin. Then, the resulting methyl-ω-sulfonic acid derivative represented by the following formula (3) and p-anisidine-3-sulfonic acid represented by the following formula (4) diazotized according to the conventional method are subjected to a coupling reaction at a reaction temperature of 0 to 15° C. and at pH 4 to 6. Subsequently, a hydrolysis reaction is performed at a reaction temperature of 80 to 95° C. and at pH 10.5 to 11.5 to obtain a compound represented by the following formula (5).

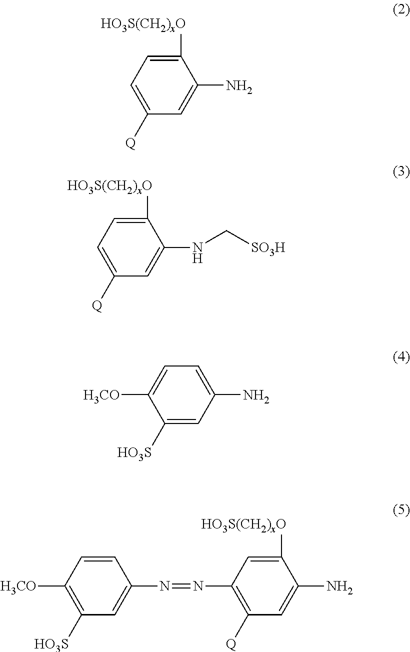

Then, the compound represented by the above formula (5) (2 equivalents) and a cyanuric halide (1 equivalent), for example, cyanuric chloride (1 equivalent) are condensed at a reaction temperature of 15 to 45° C. and at pH 5 to 8 to obtain a compound represented by the following formula (6).

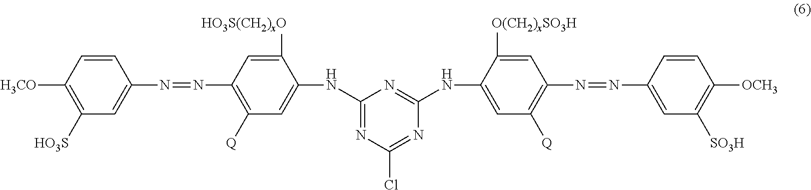

Furthermore, a chlorine atom on the triazine ring in the resulting compound represented by the above formula (6) can be substituted with a compound represented by the following formula (7-A) or (7-B) under the conditions of a reaction temperature of 55 to 95° C. and at pH 6 to 9 to obtain the compound according to the present invention represented by the above (1).

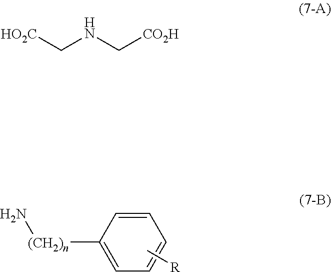

Among the compounds according to the present invention represented by the above formula (1), specific examples in a case where Y is a group represented by the above formula (A) are shown in the following Table 1. In addition, among the compounds according to the present invention of the above formula (1), specific examples in a case where Y is a group represented by the above formula (B) are shown in the following Tables 2 to 6. However, the present invention shall not be limited to these specific examples.

It should be noted that the abbreviations in Table 1 below have the following meanings. F: fluorine atom, Cl: chlorine atom, Br: bromine atom, I: iodine atom

TABLE 1

| Compound No. | Q | x |
|---|---|---|
| 1 | F | 2 |
| 2 | F | 3 |
| 3 | F | 4 |
| 4 | Cl | 2 |
| 5 | Cl | 3 |
| 6 | Cl | 4 |
| 7 | Br | 2 |
| 8 | Br | 3 |
| 9 | Br | 4 |
| 10 | I | 2 |
| 11 | I | 3 |
| 12 | I | 4 |

TABLE 2

| Compound No. | Structure |
|---|---|
| 13 | 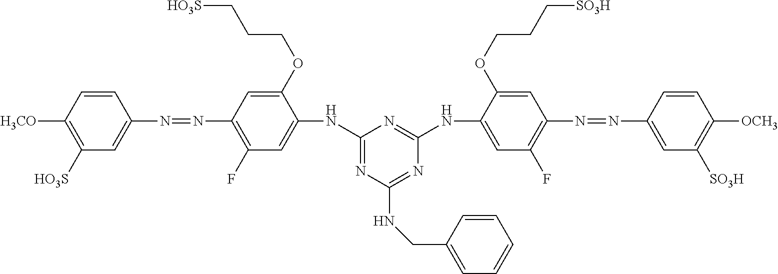 [SMILES: COc1ccc(N=Nc2cc(OCCCS(=O)(=O)O)c(Nc3nc(NCc4ccccc4)nc(Nc4cc(F)c(N=Nc5ccc(OC)c(S(=O)(=O)O)c5)cc4OCCCS(=O)(=O)O)n3)cc2F)cc1S(=O)(=O)O] |
| 14 | 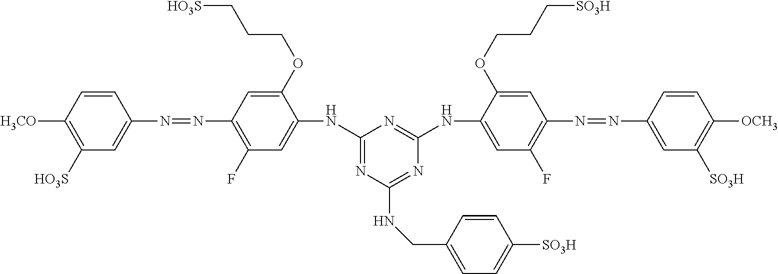 [SMILES: COc1ccc(N=Nc2cc(OCCCS(=O)(=O)O)c(Nc3nc(NCc4ccc(S(=O)(=O)O)cc4)nc(Nc4cc(F)c(N=Nc5ccc(OC)c(S(=O)(=O)O)c5)cc4OCCCS(=O)(=O)O)n3)cc2F)cc1S(=O)(=O)O] |
| 15 | 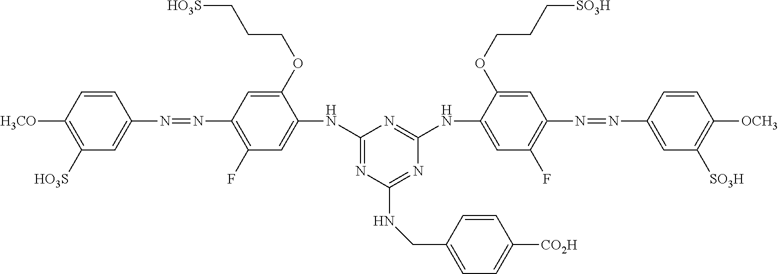 [SMILES: COc1ccc(N=Nc2cc(OCCCS(=O)(=O)O)c(Nc3nc(NCc4ccc(C(=O)O)cc4)nc(Nc4cc(F)c(N=Nc5ccc(OC)c(S(=O)(=O)O)c5)cc4OCCCS(=O)(=O)O)n3)cc2F)cc1S(=O)(=O)O] |
| 16 | 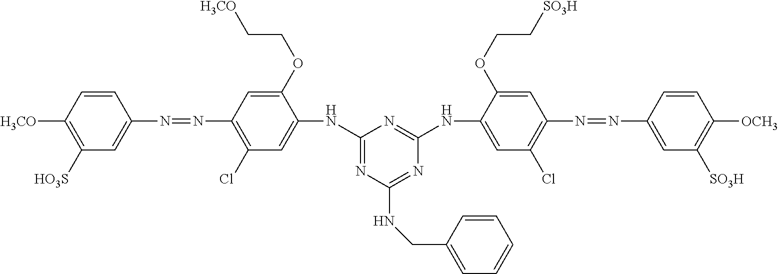 [SMILES: COCCOc1cc(N=Nc2ccc(OC)c(S(=O)(=O)O)c2)c(Cl)cc1Nc1nc(NCc2ccccc2)nc(Nc2cc(Cl)c(N=Nc3ccc(OC)c(S(=O)(=O)O)c3)cc2OCCS(=O)(=O)O)n1] |

TABLE 3

| Compound No. | Structure |
|---|---|
| 17 | 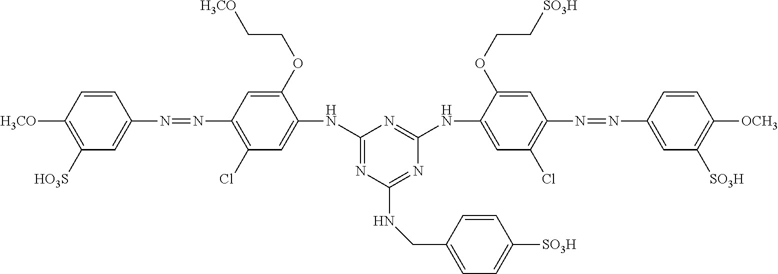 [SMILES: COCCOc1cc(N=Nc2ccc(OC)c(S(=O)(=O)O)c2)c(Cl)cc1Nc1nc(NCc2ccc(S(=O)(=O)O)cc2)nc(Nc2cc(Cl)c(N=Nc3ccc(OC)c(S(=O)(=O)O)c3)cc2OCCS(=O)(=O)O)n1] |
| 18 | 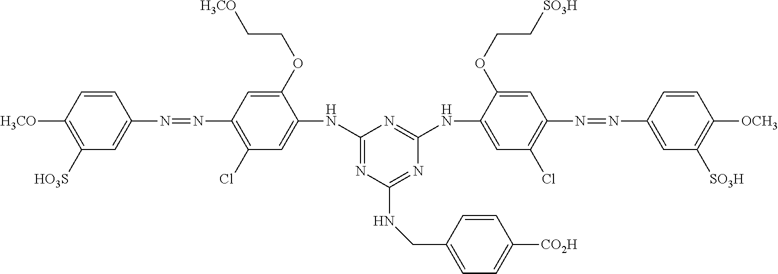 [SMILES: COCCOc1cc(N=Nc2ccc(OC)c(S(=O)(=O)O)c2)c(Cl)cc1Nc1nc(NCc2ccc(C(=O)O)cc2)nc(Nc2cc(Cl)c(N=Nc3ccc(OC)c(S(=O)(=O)O)c3)cc2OCCS(=O)(=O)O)n1] |
| 19 | 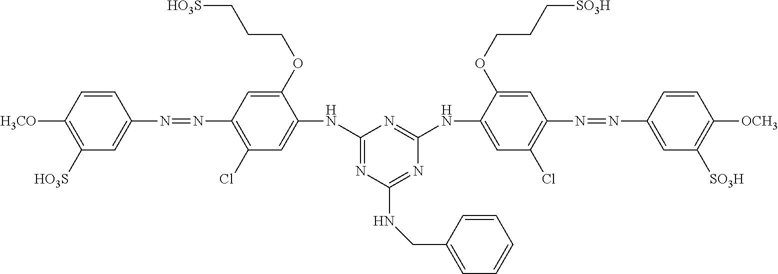 [SMILES: COc1ccc(N=Nc2cc(OCCCS(=O)(=O)O)c(Nc3nc(NCc4ccccc4)nc(Nc4cc(Cl)c(N=Nc5ccc(OC)c(S(=O)(=O)O)c5)cc4OCCCS(=O)(=O)O)n3)cc2Cl)cc1S(=O)(=O)O] |
| 20 | 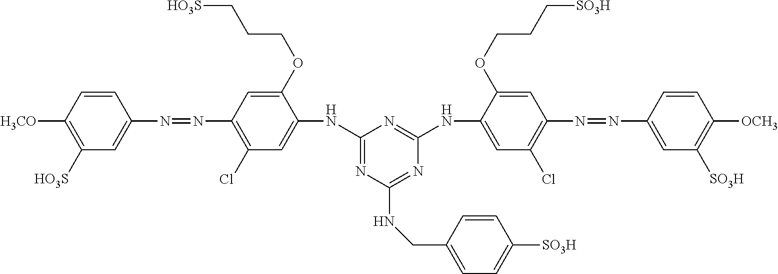 [SMILES: COc1ccc(N=Nc2cc(OCCCS(=O)(=O)O)c(Nc3nc(NCc4ccc(S(=O)(=O)O)cc4)nc(Nc4cc(Cl)c(N=Nc5ccc(OC)c(S(=O)(=O)O)c5)cc4OCCCS(=O)(=O)O)n3)cc2Cl)cc1S(=O)(=O)O] |

TABLE 4

| Compound No. | Structure |
|---|---|
| 21 | 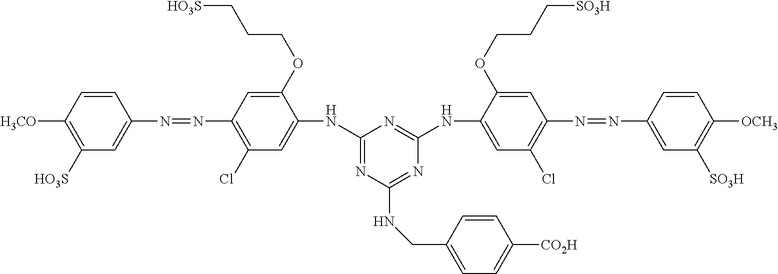 [SMILES: COc1ccc(N=Nc2cc(OCCCS(=O)(=O)O)c(Nc3nc(NCc4ccc(C(=O)O)cc4)nc(Nc4cc(Cl)c(N=Nc5ccc(OC)c(S(=O)(=O)O)c5)cc4OCCCS(=O)(=O)O)n3)cc2Cl)cc1S(=O)(=O)O] |
| 22 | 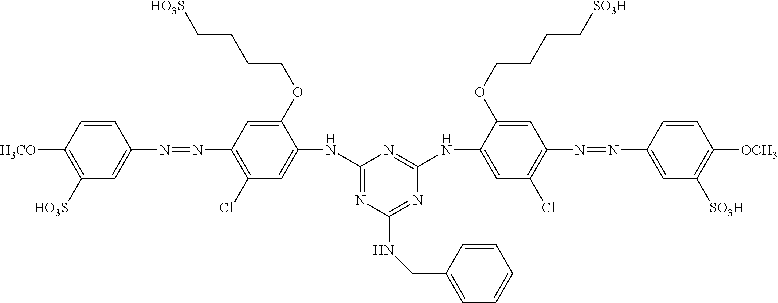 [SMILES: COc1ccc(N=Nc2cc(OCCCCS(=O)(=O)O)c(Nc3nc(NCc4ccccc4)nc(Nc4cc(Cl)c(N=Nc5ccc(OC)c(S(=O)(=O)O)c5)cc4OCCCCS(=O)(=O)O)n3)cc2Cl)cc1S(=O)(=O)O] |
| 23 | 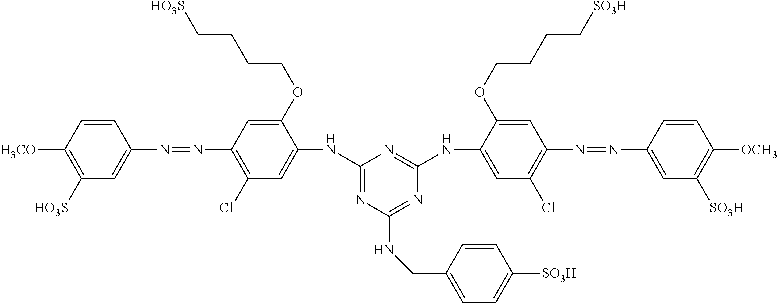 [SMILES: COc1ccc(N=Nc2cc(OCCCCS(=O)(=O)O)c(Nc3nc(NCc4ccc(S(=O)(=O)O)cc4)nc(Nc4cc(Cl)c(N=Nc5ccc(OC)c(S(=O)(=O)O)c5)cc4OCCCCS(=O)(=O)O)n3)cc2Cl)cc1S(=O)(=O)O] |
| 24 | 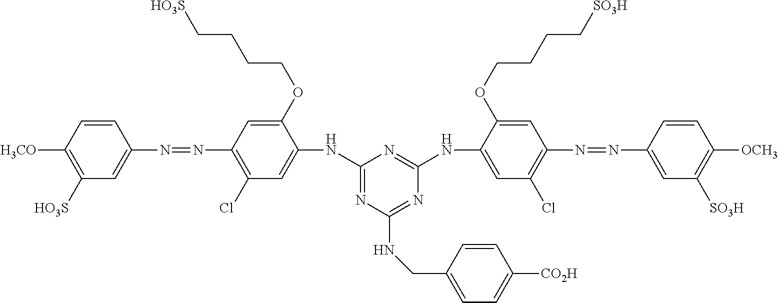 [SMILES: COc1ccc(N=Nc2cc(OCCCCS(=O)(=O)O)c(Nc3nc(NCc4ccc(C(=O)O)cc4)nc(Nc4cc(Cl)c(N=Nc5ccc(OC)c(S(=O)(=O)O)c5)cc4OCCCCS(=O)(=O)O)n3)cc2Cl)cc1S(=O)(=O)O] |

TABLE 5

| Compound No. | Structure |
|---|---|
| 25 | 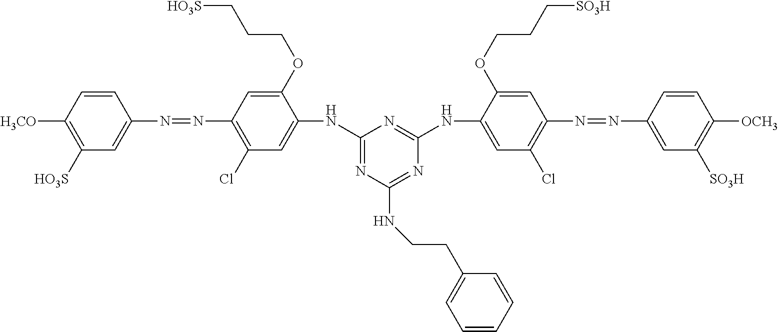 [SMILES: COc1ccc(N=Nc2cc(OCCCS(=O)(=O)O)c(Nc3nc(NCCc4ccccc4)nc(Nc4cc(Cl)c(N=Nc5ccc(OC)c(S(=O)(=O)O)c5)cc4OCCCS(=O)(=O)O)n3)cc2Cl)cc1S(=O)(=O)O] |
| 26 | 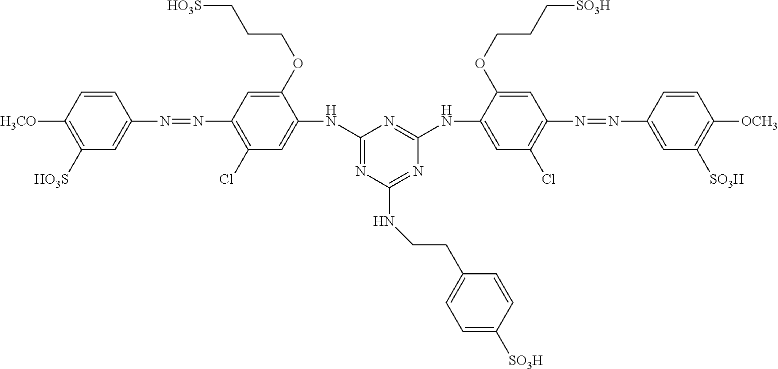 [SMILES: COc1ccc(N=Nc2cc(OCCCS(=O)(=O)O)c(Nc3nc(NCCc4ccc(S(=O)(=O)O)cc4)nc(Nc4cc(Cl)c(N=Nc5ccc(OC)c(S(=O)(=O)O)c5)cc4OCCCS(=O)(=O)O)n3)cc2Cl)cc1S(=O)(=O)O] |
| 27 | 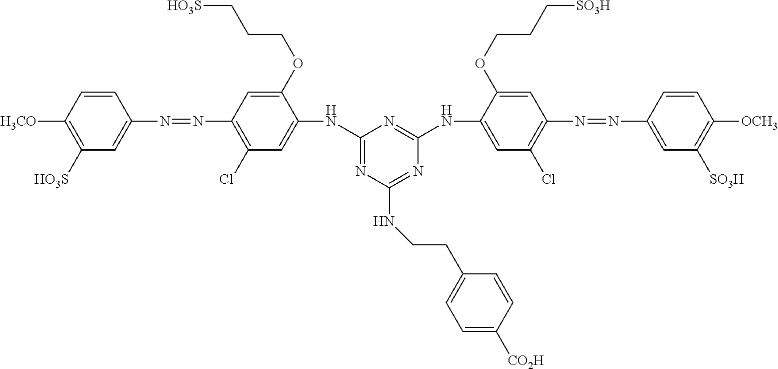 [SMILES: COc1ccc(N=Nc2cc(OCCCS(=O)(=O)O)c(Nc3nc(NCCc4ccc(C(=O)O)cc4)nc(Nc4cc(Cl)c(N=Nc5ccc(OC)c(S(=O)(=O)O)c5)cc4OCCCS(=O)(=O)O)n3)cc2Cl)cc1S(=O)(=O)O] |
| 28 | 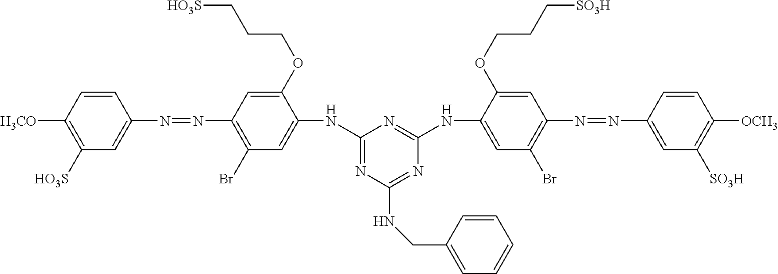 [SMILES: COc1ccc(N=Nc2cc(OCCCS(=O)(=O)O)c(Nc3nc(NCc4ccccc4)nc(Nc4cc(Br)c(N=Nc5ccc(OC)c(S(=O)(=O)O)c5)cc4OCCCS(=O)(=O)O)n3)cc2Br)cc1S(=O)(=O)O] |

TABLE 6

| Compound No. | Structure |
|---|---|
| 29 | 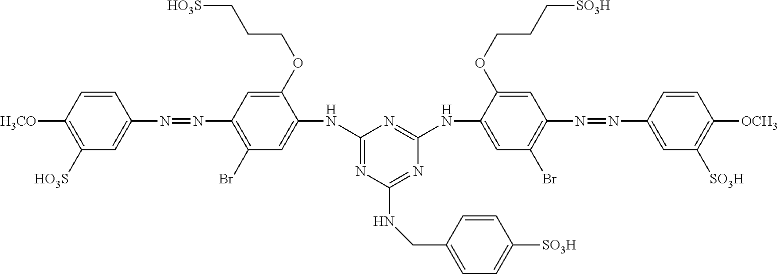 [SMILES: COc1ccc(N=Nc2cc(OCCCS(=O)(=O)O)c(Nc3nc(NCc4ccc(S(=O)(=O)O)cc4)nc(Nc4cc(Br)c(N=Nc5ccc(OC)c(S(=O)(=O)O)c5)cc4OCCCS(=O)(=O)O)n3)cc2Br)cc1S(=O)(=O)O] |
| 30 | 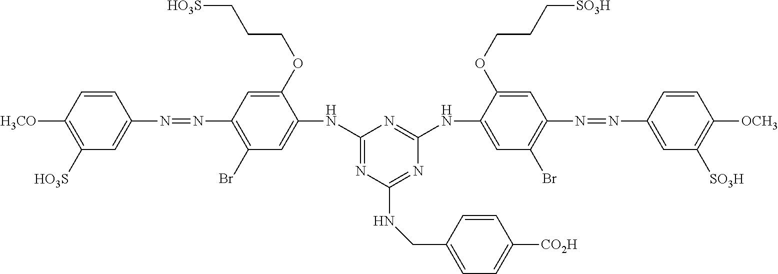 [SMILES: COc1ccc(N=Nc2cc(OCCCS(=O)(=O)O)c(Nc3nc(NCc4ccc(C(=O)O)cc4)nc(Nc4cc(Br)c(N=Nc5ccc(OC)c(S(=O)(=O)O)c5)cc4OCCCS(=O)(=O)O)n3)cc2Br)cc1S(=O)(=O)O] |
| 31 | 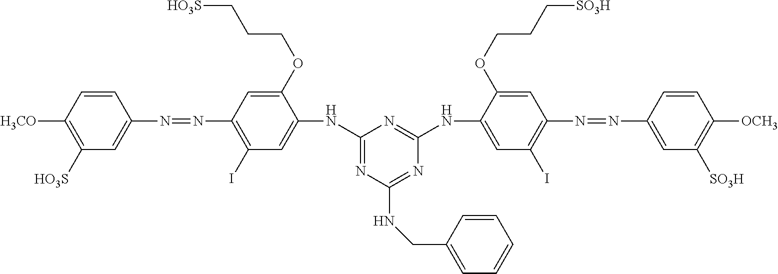 [SMILES: COc1ccc(N=Nc2cc(OCCCS(=O)(=O)O)c(Nc3nc(NCc4ccccc4)nc(Nc4cc(I)c(N=Nc5ccc(OC)c(S(=O)(=O)O)c5)cc4OCCCS(=O)(=O)O)n3)cc2I)cc1S(=O)(=O)O] |
| 32 | 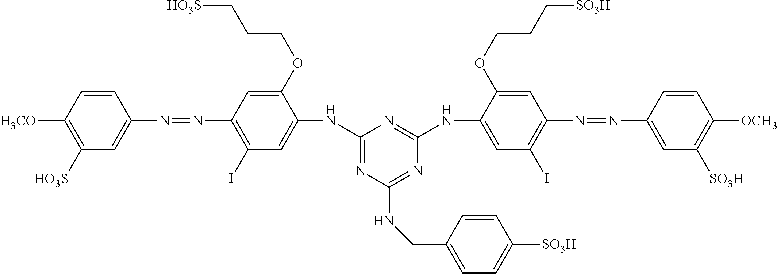 [SMILES: COc1ccc(N=Nc2cc(OCCCS(=O)(=O)O)c(Nc3nc(NCc4ccc(S(=O)(=O)O)cc4)nc(Nc4cc(I)c(N=Nc5ccc(OC)c(S(=O)(=O)O)c5)cc4OCCCS(=O)(=O)O)n3)cc2I)cc1S(=O)(=O)O] |
| 33 | 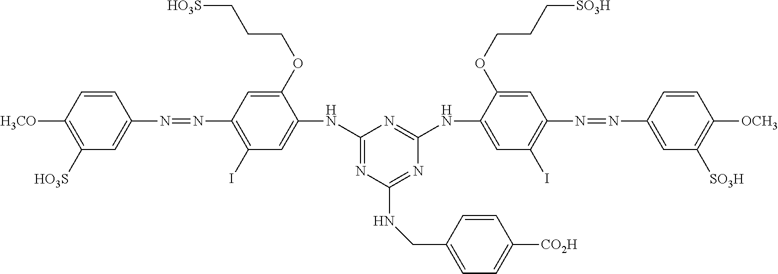 [SMILES: COc1ccc(N=Nc2cc(OCCCS(=O)(=O)O)c(Nc3nc(NCc4ccc(C(=O)O)cc4)nc(Nc4cc(I)c(N=Nc5ccc(OC)c(S(=O)(=O)O)c5)cc4OCCCS(=O)(=O)O)n3)cc2I)cc1S(=O)(=O)O] |

The compound represented by the above formula (1) may also be present as a free acid or a salt thereof. Salts of the compound represented by the above formula (1) include salts with inorganic or organic cations. Specific examples of a salt with an inorganic cation include those salts such as alkali metal salts, for example, lithium salts, sodium salts, potassium salts; and ammonium salts (NH⁴⁺). Specific examples of a salt with an organic cation include, but not limited to, those salts with a quaternary ammonium represented by the following formula (8).

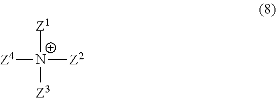

In the above formula (8), Z¹ to Z⁴ are each independent with represent to a hydrogen atom, a C1-C4 alkyl group, a hydroxy C1-C4 alkyl group or a hydroxy C1-C4 alkoxy C1-C4 alkyl group, and at least one of Z¹ to Z⁴ is a group other than a hydrogen atom.

Here, examples of the above C1-C4 alkyl group in Z¹ to Z⁴ include methyl, ethyl and the like. Similarly, examples of the above hydroxy C1-C4 alkyl group include hydroxymethyl, hydroxyethyl, 3-hydroxypropyl, 2-hydroxypropyl, 4-hydroxybutyl, 3-hydroxybutyl, 2-hydroxybutyl and the like. Similarly, examples of the above hydroxy C1-C4 alkoxy C1-C4 alkyl group include hydroxyethoxymethyl, 2-hydroxyethoxyethyl, 3-(hydroxyethoxy)propyl, 3-(hydroxyethoxy)butyl, 2-(hydroxyethoxy)butyl and the like.

Those preferred among the above salts include alkali metal salts such as sodium, potassium, lithium; organic quaternary ammonium salts such as those salts with monoethanolamine, diethanolamine, triethanolamine, monoisopropanolamine, diisopropanolamine, triisopropanolamine; ammonium salts and the like. Among these, more preferred are lithium salts, sodium salts and ammonium salts.

As obvious to a person skilled in the art, a salt or a free acid of the compound represented by the above formula (1) can easily be obtained by the following method and the like.

For example, a solid precipitated by a method such as a method of adding, for example: a water-soluble organic solvent such as acetone and C1-C4 alcohol; or sodium chloride for salt precipitation, to a reaction liquid after the completion of the last step in a synthesis reaction of the compound represented by the above formula (1) or an aqueous solution comprising a salt of the compound represented by the above formula (1) can be filtrated and separated to obtain a sodium salt of the compound represented by the above formula (1) and the like as a wet cake.

In addition, a free acid of the compound represented by the above formula (1) or a mixture of a sodium salt and a free acid in which a portion of the compound represented by the above formula (1) is a sodium salt can be obtained by dissolving a wet cake of the resulting sodium salt in water, and adding an acid such as hydrochloric acid to adjust a pH thereof, and filtering and separating a precipitated solid.

Furthermore, an ammonium salt of the compound represented by the above formula (1) can be obtained by dissolving a wet cake of the resulting sodium salt or a dried solid thereof into water, and then adding an ammonium salt such as ammonium chloride, and adding an acid such as hydrochloric acid to adjust a pH thereof, for example, to 1 to 3, and filtering and separating a precipitated solid. A mixture of an ammonium salt of the compound represented by the above formula (1) and a sodium salt; a mixture of a free acid of the compound represented by the above formula (1) and an ammonium salt; and the like can also be obtained by appropriately adjusting the amount of ammonium chloride to be added and/or adjusting the pH.

Alternatively, a solid of a free acid can directly be obtained by adding a mineral acid (for example, hydrochloric acid, sulfuric acid and the like) to a reaction liquid after the completion of the above reaction as described below. In this case, depending on the respective compound being added, a potassium salt; a lithium salt; an ammonium salt; a quaternary ammonium salt; and the like can also be obtained by adding a wet cake of a free acid of the compound represented by the above formula (1) into water and stirring it, and producing a salt by adding, for example, potassium hydroxide; lithium hydroxide; aqueous ammonia; or a hydroxide of the organic quaternary ammonium represented by the above formula (8); and the like. For example, a salt mixture of a lithium salt and a sodium salt and the like; in addition, a salt mixture of a lithium salt, a sodium salt and an ammonium salt and the like can also be prepared by restricting the number of moles of the above hydroxide and the like to be added relative to the number of moles of the free acid. A salt of the compound represented by the above formula (1) may show varied physical properties such as solubility or varied ink performances when used in an ink, depending on a type of the salt. Therefore, the type of the salt may also be preferably selected according to the target ink performance and the like.

The compound according to the present invention represented by the above formula (1) may be isolated as a solid free acid by adding a mineral acid such as hydrochloric acid after the completion of the reaction. Inorganic salts contained as impurities (inorganic impurities), for example, sodium chloride, sodium sulfate and the like can be removed, for example, by washing a solid of the resulting free acid with water or acidic water such as aqueous hydrochloric acid. In the case of a free acid of the compound according to the present invention obtained as described above, a solution of a salt of the corresponding compound can be obtained by treating the resulting wet cake or a dried solid thereof with a desired inorganic or organic base in water. Inorganic bases include, for example, hydroxides of alkali metals such as lithium hydroxide, sodium hydroxide, potassium hydroxide; carbonates of alkali metals such as lithium carbonate, sodium carbonate, potassium carbonate; ammonium hydroxide (aqueous ammonia); and the like. Examples of an organic base include, but not limited to, for example, organic amines corresponding to the quaternary ammonium represented by the above formula (8), for example, alkanolamine and the like such as diethanolamine and triethanolamine.

The compound according to the present invention is suitable for dying of natural and synthetic fiber materials or mixed fabric articles, as well as for manufacturing of an ink for writing and an ink composition for ink-jet recording. For example, a reaction liquid after the completion of the last step in a synthesis reaction of the compound according to the present invention represented by the above formula (1) can also be used directly for manufacturing of the ink composition according to the present invention. Alternatively, the reaction liquid can be dried, for example, by the method described above or by a method of spray drying and the like to isolate the above compound, and then the resulting compound can also be processed into an ink composition.

The ink composition according to the present invention can be prepared by dissolving the compound represented by the above formula (1) in water or a mixed solution (also referred to as an aqueous medium) of water and a water-soluble organic solvent (an organic solvent which is miscible with water), and adding an ink preparation agent, if desired. In a case where this ink composition is used as an ink for ink-jet printers, it is preferable to use an ink with a smaller content of inorganic impurites such as chlorides with metal cations contained as impurities, for example, sodium chloride; sulfates, for example, sodium sulfate. In this case, for example, the total content of sodium chloride and sodium sulfate may be about 1 mass % or less relative to the total mass of the compound represented by the above formula (1), and the lower limit may be 0 mass %, i.e., the detection limit of a detector or less. Methods of manufacturing a compound with less inorganic impurities include, for example, a method in which a reverse osmotic membrane publicly known by itself is used; a method in which a dried article or a wet cake of the compound according to the present invention is added to, for example, a water-soluble organic solvent such as acetone and C1-C4 alcohol (for example, methanol, ethanol, isopropanol and the like) or a water-containing water-soluble organic solvent, and suspension purification or crystallization is performed. Desalting treatment and the like may be performed by these methods.

The ink composition according to the present invention contains the compound represented by the above formula (1) in an amount of usually 0.1 to 20 mass %, preferably 1 to 10 mass % and more preferably 2 to 8 mass % relative to the total mass of the ink composition.

The ink composition according to the present invention can be prepared using water as a medium, and may appropriately contain a water-soluble organic solvent and an ink preparation agent if desired as long as the effects of the present invention are not impaired.

A water-soluble organic solvent may show the following effects of: dissolving dyes; preventing a composition from drying (maintaining a wet condition); adjusting the viscosity of a composition; promoting permeation of a pigment into a recording material; adjusting the surface tension of a compound; defoaming of a compound; and the like, and is therefore preferably contained in the ink composition according to the present invention.

Ink preparation agents include, for example, known additives such as antiseptic and antifungal agents, a pH adjusting agent, a chelating reagent, a rust preventive agent, an ultraviolet absorbing agent, a viscosity adjusting agent, a dye-dissolving agent, an anti-fading agent, a surface tension adjusting agent, a defoaming agent and the like.

The content of a water-soluble organic solvent may be 0 to 60 mass %, preferably 10 to 50 mass % relative to the total mass of the ink composition according to the present invention, and the content of an ink preparation agent may be 0 to 20 mass %, preferably 0 to 15 mass %. The ink composition according to the present invention comprises the compound represented by the above formula (1), a water-soluble organic solvent and an ink preparation agent, with the balance being water.

Examples of the above water-soluble organic solvent include, for example, C1-C4 alcohols such as methanol, ethanol, n-propanol, isopropanol, n-butanol, isobutanol, secondary butanol, tertiary butanol; amides such as N,N-dimethylformamide. N,N-dimethylacetamide; heterocyclic ketones such as 2-pyrrolidone, N-methyl-2-pyrrolidone, hydroxyethyl-2-pyrrolidone, 1,3-dimethylimidazolidin-2-one, 1,3-dimethylhexahydropyrimid-2-one; ketones or keto alcohols such as acetone, methyl ethyl ketone, 2-methyl-2-hydroxypentan-4-one; cyclic ethers such as tetrahydrofuran, dioxane; mono-, oligo- or polyalkylene glycol or thioglycol having a C2-C6 alkylene unit such as ethylene glycol, 1,2- or 1,3-propylene glycol, 1,2- or 1,4-butylene glycol, 1,6-hexylene glycol, diethylene glycol, triethylene glycol, tetraethylene glycol, dipropylene glycol, polyethylene glycol, polypropylene glycol, thiodiglycol; polyols (preferably triols) such as trimethylolpropane, glycerin, hexane-1,2,6-triol; C1-C4 monoalkyl ethers of polyhydric alcohols such as ethylene glycol monomethyl ether, ethylene glycol monoethyl ether, diethylene glycol monomethyl ether, diethylene glycol monoethyl ether, diethylene glycol monobutyl ether (butylcarbitol), triethylene glycol monomethyl ether, triethylene glycol monoethyl ether; γ-butyrolactone; dimethyl sulfoxide; and the like.

It should be noted that a substance, for example, trimethylolpropane and the like, which is solid at ambient temperature is also contained in the above water-soluble organic solvent. Nonetheless, the above substance is solid but water soluble, and an aqueous solution containing the above substance shows similar characteristics to those of the water-soluble organic solvent and can therefore be used with expectation of the same effect. Given this, in the present specification, such a solid substance shall be included within the category of water-soluble organic solvents for convenience as long as it can be used for the same purpose with expectation of the same effect as described above.

Preferred as the aforementioned water-soluble organic solvent are isopropanol, glycerin, mono-, di- or triethylene glycol, dipropylene glycol, 2-pyrrolidone, hydroxyethyl-2-pyrrolidone, N-methyl-2-pyrrolidone, trimethylolpropane and butylcarbitol. More preferred are isopropanol, glycerin, diethylene glycol, 2-pyrrolidone, N-methyl-2-pyrrolidone and butylcarbitol. These water-soluble organic solvents are used alone or in combination.

Examples of the aforementioned antiseptic and antifungal agents include, for example, organic sulfur-based, organic nitrogen sulfur-based, organic halogen-based, haloallylsulfone-based, iodopropargyl-based, N-haloalkylthio-based, benzothiazole-based, nitrile-based, pyridine-based, 8-oxyquinoline-based, isothiazoline-based, dithiol-based, pyridinoxide-based, nitropropane-based, organic tin-based, phenol-based, quaternary ammonium salt-based, triazine-based, thiadiazine-based, anilide-based, adamantane-based, dithiocarbamate-based, brominated indanon-based, benzyl bromoacetate-based, inorganic salt-based compounds and the like. Examples of the organic halogen-based compound include, for example, sodium pentachlorophenate.

Examples of the pyridinoxide-based compound include, for example, sodium 2-pyridinethiol-1-oxide.

Examples of the isothiazoline-based compound include, for example, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesium chloride, 5-chloro-2-methyl-4-isothiazolin-3-one calcium chloride, 2-methyl-4-isothiazolin-3-one calcium chloride and the like.

Examples of the other antiseptic and antifungal agents include sodium acetate, sodium sorbate, sodium benzoate and the like; and further include Proxel® GXL (S) and Proxel® XL-2 (S), which are product names and available from Arch Chemicals, Inc. It should be noted that “RTM” in superscript used herein means a registered trademark.

Any substance can be used as a pH adjusting agent as long as it can control the pH of an ink within the range between 6.0 and 11.0 for the purpose of improving the storage stability of the ink. Examples include alkanolamines such as diethanolamine, triethanolamine; hydroxides of alkali metals such as lithium hydroxide, sodium hydroxide, potassium hydroxide; ammonium hydroxide; carbonates of alkali metals such as lithium carbonate, sodium carbonate, potassium carbonate; aminosulfonic acid such as taurine; and the like.

Examples of the chelating reagent include, for example, disodium ethylenediaminetetraacetate, sodium nitrilotriacetate, sodium hydroxyethylethylenediaminetriacetate, sodium diethylenetriaminepentaacetate, sodium uracildiacetate and the like.

Examples of the rust preventive agent include, for example, hydrogen sulfite salt, sodium thiosulfate, ammonium thioglycolate, diisopropylammonium nitrite, pentaerythritol tetranitrate, dicyclohexylammonium nitrite and the like.

Examples of the ultraviolet absorbing agent include, for example, benzophenone-based compounds, benzotriazole-based compounds, cinnamic acid-based compounds, triazine-based compounds, stilbene-based compounds. In addition, a compound which absorbs ultraviolet light and emits fluorescence, so-called fluorescent whitening agents, represented by benzoxazole-based compounds, can also be used.

Examples of the viscosity adjusting agent include, in addition to water-soluble organic solvents, water-soluble polymer compounds such as, polyvinyl alcohol, cellulose derivatives, polyamine, polyimine and the like.

Examples of the dye-dissolving agents include, for example, urea, ε-caprolactam, ethylene carbonate and the like. Among these, urea is preferably used.

An anti-fading agent is used for the purpose of improving the preserving property of images. As the anti-fading agent, various organic and metal complex-based anti-fading agents can be used. Examples of the organic anti-fading agent include hydroquinones, alkoxyphenols, dialkoxyphenols, phenols, anilines, amines, indans, chromans, alkoxyanilines, heterocycles and the like. Metal complexes include nickel complexes, zinc complexes and the like.

Examples of the surface tension adjusting agent include a surfactant, for example, an anionic surfactant, an amphoteric surfactant, a cationic surfactant, a nonionic surfactant and the like.

Examples of the anionic surfactant include alkylsulfocarboxylate, α-olefin sulfonate, polyoxyethylene alkyl ether acetate, N-acylamino acid and a salt thereof, N-acylmethyltaurine salt, alkylsulfate polyoxyalkyl ether sulfate, alkylsulfate polyoxyethylene alkyl ether phosphate, rosin acid soap, castor oil sulfate ester salt, lauryl alcohol sulfate ester salt, alkylphenol-type phosphate ester, alkyl-type phosphate ester, alkylallylsulfonate, diethyl sulfosuccinate, diethylhexyl sulfosuccinate, dioctyl sulfosuccinate and the like.

Examples of the cationic surfactant include 2-vinylpyridine derivatives, poly 4-vinylpyridine derivatives and the like.

Examples of the amphoteric surfactant include lauryldimethylaminoacetic acid betaine, 2-alkyl-N-carboxymethyl-N-hydroxyethyl imidazolinium betaine, coconut oil fatty acid amide propyldimethylaminoacetic acid betaine, polyoctylpolyaminoethylglycine, and in addition, imidazoline derivatives and the like.

Examples of the nonionic surfactant include those based on ether such as polyoxyethylene nonylphenyl ether, polyoxyethylene octylphenyl ether, polyoxyethylene dodecylphenyl ether, polyoxyethylene oleyl ether, polyoxyethylene lauryl ether, polyoxyethylene alkyl ether; those based on ester such as polyoxyethylene oleate ester, polyoxyethylene distearate ester, sorbitan laurate, sorbitan monostearate, sorbitan monooleate, sorbitan sesquioleate, polyoxyethylene monooleate, polyoxyethylene stearate; those based on acetylene glycols (alcohols) such as 2,4,7,9-tetramethyl-5-decyne-4,7-diol, 3,6-dimethyl-4-octyne-3,6-diol, 3,5-dimethyl-1-hexyn-3-ol; Surfynol® 104, 82, 465, Olfine® STG, which are product names and available from Nissin Chemical Industry Co., Ltd.; Tergitol® 15-S-7, which is a product name and available from SIGMA-ALDRICH; and the like.

Examples of the defoaming agent include highly oxidized oil-based, glycerine fatty acid ester-based, fluorine-based, silicone-based compounds.

These ink conditioning agents are used alone or in combination. It should be noted that the surface tension of the ink composition according to the present invention is usually 25 to 70 mN/m and preferably 25 to 60 mN/m, and the viscosity is preferably 30 mPa·s or less, and preferably adjusted to 20 mPa·s or less.

There is no particular limitation in the order of dissolution of those chemicals such as additives in manufacture of the ink composition according to the present invention. Water with little impurities such as ion exchange water, distilled water and the like is preferably used for preparing an ink composition. Furthermore, after preparation of the ink composition, precision filtration may be performed with a membrane filter and the like to remove foreign substances in the ink composition, if necessary. In particular, in a case where the ink composition according to the present invention is used as an ink for ink-jet recording, precision filtration is preferably performed. The pore diameter of the filter used for the precision filtration is usually 1 to 0.1 μm, preferably 0.8 to 0.1 μm.

An ink composition containing the compound according to the present invention is suitable for use in textile printing, copying, marking, writing, drawing, stamping or recording (printing), and particularly suitable for use in ink-jet recording. In addition, the ink composition according to the present invention does not easily undergo solid precipitation even when dried near a nozzle of a recording head of an ink-jet printer. Therefore, the blocking of the recording head also does not occur easily.

As a method of recording on a recording material by the ink-jet recording method according to the present invention, the following can be exemplified. That is, mentioned is a method comprising loading a container filled with the ink composition according to the present invention at a predetermined position of an ink-jet printer, using the ink composition according to the present invention as an ink, and discharging an ink droplet of the above ink in response to a recording signal to allow attachment to a recording material, thereby performing recording. Examples of the ink-jet printer include: one employing the piezo system in which mechanical vibration is utilized; one employing the bubble jet (registered trademark) system in which a bubble produced by heating is utilized; and the like. Any systems can be employed for the ink-jet recording method according to the present invention.

Two types of inks containing the same pigment may be loaded in a single ink-jet printer for the purpose of obtaining a higher definition recorded image. The difference between the aforementioned two types of inks is the content of a pigment: one has a higher content, and the other has a lower content. They are used as an ink set. The ink composition according to the present invention can also be used as such an ink set. The ink composition according to the present invention may also be used in one of an ink set, and a known ink (composition) may be used in the other.

The ink composition according to the present invention may also be used as a yellow ink composition containing a compound according to the present invention and a known yellow pigment for the purpose of fine-tuning of a hue and the like, to such a degree that the effect to be obtained by the present invention is not impaired. In addition, the compound according to the present invention can be used in combination with a magenta pigment or a cyan pigment for the purpose of toning of other color inks, for example a black ink, or for the purpose of preparing a red ink and a green ink. Furthermore, color inks of magenta, cyan, and if necessary, green, blue (or violet), red, black, etc. can also be used in combination with the ink composition according to the present invention for the purpose of obtaining full-color recorded images. In this case, containers are filled with inks of respective colors, the containers being loaded at predetermined positions of the ink-jet printer for use in ink-jet recording.

As the recording material used for the ink-jet recording method according to the present invention, for example, an information transmission sheet such as paper, film, etc.; fiber and cloth (cellulose, nylon, wool and the like); leather; a substrate for a color filter; and the like. The information transmission sheet is preferred. The information transmission sheet is not particularly limited, and not only regular paper but also a surface-treated sheet, specifically one having an ink receiving layer on a substrate such as paper, synthetic paper, film, etc. can be used. The ink receiving layer serves to absorb an ink for accelerating drying thereof. The ink receiving layer can be provided by, for example, a method in which the aforementioned substrate is impregnated in or painted with a cation-based polymer; a method in which inorganic particles capable of absorbing a pigment in an ink is applied on a surface of the aforementioned substrate along with a hydrophilic polymer such as polyvinyl alcohol and polyvinylpyrrolidone; and the like. As a material for the inorganic particles capable of absorbing a pigment in an ink, porous silica, alumina sol, special ceramics and the like can be exemplified.

An information transmission sheet having such an ink receiving layer is generally called ink-jet paper, ink-jet film, glossy paper, glossy film and the like. Examples of a typical commercial product of the information transmission sheet having an ink receiving layer include: Professional photograph paper, Canon photograph paper Glossy Pro [platinum grade] and Glossy Gold, which are product names and available from Canon, Inc.; Photograph paper Crispia (high-glossy), Photograph paper (glossy), which are product names and available from Seiko Epson Corporation; Advanced photograph paper (glossy), which is a product name and available from Hewlett Packard Japan Inc.; Gasai Photo-finishing Pro, which is a product name and available from FUJIFILM Corporation; Photograph glossy paper BP71G, which is a product name and available from Brother Industries, Ltd.; and the like.

It should be noted that the regular paper indicates paper which does not have an ink receiving layer, and a wide variety of products are available depending on applications. Among the commercially available regular paper, those for ink-jet recording include Double-sided high quality regular paper (Seiko Epson Corporation); PB PAPER GF-500 (Canon, Inc.); Multipurpose Paper, All-in-one Printing Paper (Hewlett Packard); and the like. Plain paper copy (PPC) paper, a use of which is not particularly limited to ink-jet recording, also falls within the category of the regular paper.

The colored article according to the present invention means a colored material colored with any of the following three: (a) the water-soluble azo compound according to the present invention; (b) the ink composition according to the present invention containing the above compound; and (c) the ink composition according to the present invention containing the above compound and a water-soluble organic solvent. The material to be colored is not particularly limited, and examples thereof include, but not limited to, the aforementioned recording material. One obtained by coloring the aforementioned recording material is preferably mentioned. A method of coloring the material is not particularly limited, and examples thereof include: printing methods such as the dip dyeing method, the textile printing method and the screen printing method; the ink-jet recording method according to the present invention; and the like. The ink-jet recording method according to the present invention is preferred. Among the aforementioned colored articles, one colored by the ink-jet recording method according to the present invention is preferred.

The water-soluble azo compound according to the present invention represented by the above formula (1) has excellent solubility in water and in a water-soluble organic solvent. Furthermore, it is characterized by, for example, good filterability with a membrane filter in the course of manufacturing the ink composition according to the present invention. The ink composition according to the present invention can create extremely vivid recorded images having high color saturation and printing density with the ideal hue of yellow color on a recording material such as the regular paper and the information transmission sheet having an ink receiving layer. Therefore, full-color images with a photographic quality can faithfully be reproduced on paper. Moreover, the ink composition according to the present invention does not show solid precipitation, changes in physical properties, a hue change, and the like after prolonged storage, demonstrating very good storage stability.

When the ink composition according to the present invention is used as an ink-jet ink, solid precipitation rarely occurs due to drying of the ink composition near a nozzle, and blocking of an injection device (recording head) does not occur. Moreover, the ink composition according to the present invention does not undergo changes in physical properties even when used in a continuous ink-jet printer by recirculating an ink after relatively prolonged time intervals or even when used intermittently in an on-demand ink-jet printer.

Furthermore, an image recorded on the information transmission sheet having the ink receiving layer using the ink composition according to the present invention exhibits various types of fastness such as water resistance, moisture resistance, ozone gas resistance, abrasion resistance, light resistance. In particular they have good ozone gas resistance and light resistance. Therefore, they also have a long-term storage stability of images with a photographic quality is also excellent for these reasons. In addition, the ink composition according to the present invention has excellent color saturation, brightness and printing density (color-developing properties) on regular paper as compared with the conventional ink. In particular, the color saturation and printing density are superior.

As described above, the water-soluble azo compound according to the present invention represented by the above formula (1) and the ink composition according to the present invention containing the above compound are extremely useful for various recording inks, in particular for ink-jet recording inks.

### EXAMPLES

The present invention will be described hereinafter more specifically with reference to Examples, but the present invention shall not be limited to Examples. It should be noted that, unless otherwise stated, the terms “part” and “%” are based on mass, and the term “reaction temperature” refers to an internal temperature. Among synthesized compounds, for those of which Amax (maximum absorption wavelength) was measured; values measured in an aqueous solution at pH 7 to 8 were reported. Moreover, in the structural formula of each compound obtained in Examples, acidic functional groups such as a carboxy group and a sulfo group are shown in a form of a free acid.

It should be noted that the solubility of the compounds according to the present invention obtained from Examples was 100 g/L or more in water at room temperature.

### Example 1

### Step 1

While adjusting the pH to 7 with sodium hydroxide, 20.3 parts of p-anisidine-3-sulfonic acid was dissolved in 200 parts of water, and then 7.2 parts of sodium nitrite was added thereto. This solution was added dropwise to 200 parts of 5% hydrochloric acid over 30 minutes at 0 to 10° C., and then a diazotization reaction was performed with stirring for 1 hour at 10° C. or below to prepare a diazo reaction liquid.

Meanwhile, 26.6 parts of 2-(3-sulfopropoxy)-5-chloroaniline was dissolved in 130 parts of water while adjusting the pH to 7 with sodium hydroxide, and a methyl-ω-sulfonic acid derivative was obtained by the conventional method using 10.4 parts of sodium bisulfite and 8.6 parts of 35% formalin. The resulting methyl-ω-sulfonic acid derivative was added to the diazo reaction liquid prepared above, and stirred for 24 hours at 0 to 15° C., at pH 4 to 6. After adjusting the pH to 11 with sodium hydroxide, the reaction liquid was stirred for 5 hours at 80 to 95° C. while maintaining that pH, and 100 parts of sodium chloride was added for salt precipitation. The resulting precipitated solid was then filtered and separated to obtain 100 parts of the azo compound represented by the following formula (9) as a wet cake.

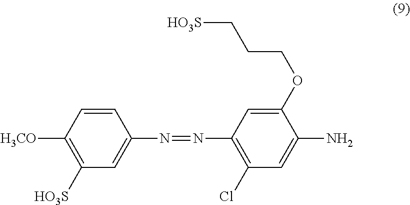 [SMILES: COc1ccc(N=Nc2cc(OCCCS(=O)(=O)O)c(N)cc2Cl)cc1S(=O)(=O)O]

### Step 2

To 250 parts of ice water, 0.1 parts of Leocol® TD90 (surfactant), which is a product name and available from Lion Corporation, was added and vigorously stirred. 3.6 parts of cyanuric chloride was added thereto and stirred for 30 minutes at 0 to 5° C. to obtain a suspension liquid. Subsequently, 100 parts of the wet cake of the compound represented by the above formula (9) was dissolved in 200 parts of water to obtain a solution. This solution was added dropwise to the above suspension liquid over 30 minutes. After the completion of the dropwise addition, it was stirred for 6 hours at pH 6 to 8, at 25 to 45° C. To the resulting reaction liquid, 9.1 parts of iminodiacetic acid was added, and stirred for 5 hours at pH 7 to 9, at 75 to 90° C. After cooling the resulting reaction liquid to 20 to 25° C., 2000 parts of 2-propanol was added to this reaction liquid, and stirred for 2 hours at 20 to 25° C. The resulting precipitated solid was filtered and separated to obtain 92.1 parts of a wet cake. By drying this wet cake with a 80° C. hot-air dryer, 14.3 parts of a sodium salt of the water-soluble azo compound according to the present invention represented by the following formula (10) (Amax: 410.0 nm) was obtained.

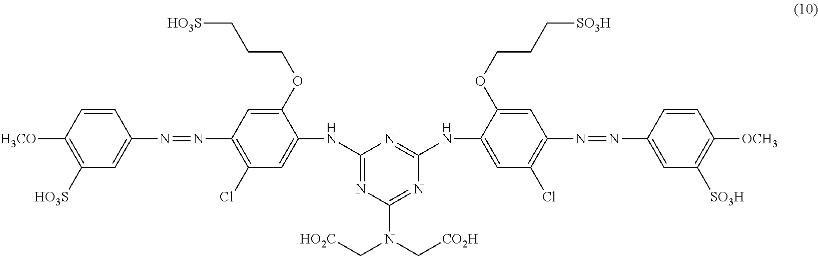 [SMILES: COc1ccc(N=Nc2cc(OCCCS(=O)(=O)O)c(Nc3nc(Nc4cc(Cl)c(N=Nc5ccc(OC)c(S(=O)(=O)O)c5)cc4OCCCS(=O)(=O)O)nc(N(CC(=O)O)CC(=O)O)n3)cc2Cl)cc1S(=O)(=O)O]

### Example 2

To 250 parts of ice water, 0.1 parts of Product name Leocol® TD90 from Lion Corporation was added and vigorously stirred. 3.6 parts of cyanuric chloride was added thereto, and stirred for 30 minutes at 0 to 5° C. to obtain a suspension liquid. Subsequently, 100 parts of the wet cake of the compound represented by the above formula (9) obtained from Example 1 (Step 1) was dissolved in 200 parts of water to obtain a solution. This solution was added dropwise to the above suspension liquid over 30 minutes. After the completion of the dropwise addition, it was stirred for 6 hours at pH 6 to 8 and at 25 to 45° C. To the resulting reaction liquid, 10.3 parts of 4-aminomethylbenzoic acid was added, and stirred for 2 hours at pH 7 to 9 and at 75 to 90° C. After cooling the resulting reaction liquid to 20 to 25° C., 2000 parts of 2-propanol was added to the reaction liquid, and stirred for 2 hours at 20 to 25° C. The resulting precipitated solid was filtered and separated to obtain 92.1 parts of a wet cake. By drying this wet cake in a 80° C. hot-air dryer, 14.3 parts of a sodium salt of the water-soluble azo compound according to the present invention represented by the following formula (11) (Amax: 407.0 nm) was obtained.

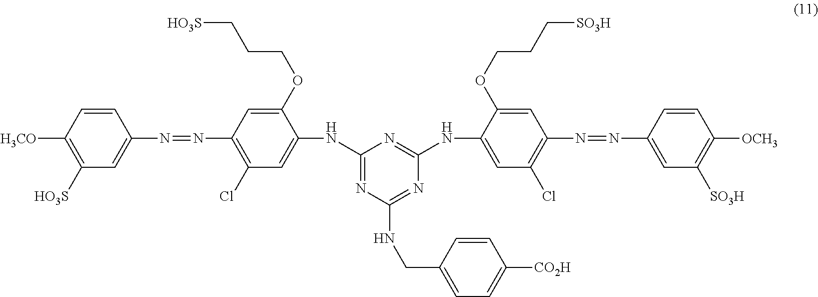 [SMILES: COc1ccc(N=Nc2cc(OCCCS(=O)(=O)O)c(Nc3nc(NCc4ccc(C(=O)O)cc4)nc(Nc4cc(Cl)c(N=Nc5ccc(OC)c(S(=O)(=O)O)c5)cc4OCCCS(=O)(=O)O)n3)cc2Cl)cc1S(=O)(=O)O]

### Examples 3 and 4

### (A) Preparation of Ink

Materials in the composition shown in the following Table 7 were mixed into a solution using the azo compound according the present invention obtained from the above Examples 1 and 2 (a sodium salt of the compound represented by the formulae (10) and (11)) as a pigment to obtain the ink composition according to the present invention. A test ink was prepared by filtering the resulting ink composition with a 0.45 μm membrane filter to remove impurities. It should be noted that the pH of the test ink was in the range between 8.0 and 9.5. Furthermore, as the “surfactant” in the following Table 7, used was Surfynol® 104 PG50, which is a product name and available from Nissin Chemical, Inc. Example 3 is preparation of an ink by using the compound obtained in Example 1. Example 4 is preparation of an ink by using the compound obtained in Example 2.

TABLE 7
Composition of ink composition

| | | |
|---|---|---|
| Compound obtained in each Example | 3.5 | parts |
| Glycerin | 5.0 | parts |
| Urea | 5.0 | parts |
| N-methyl-2-pyrrolidone | 4.0 | parts |
| Isopropyl alcohol | 3.0 | parts |
| Butylcarbitol | 2.0 | parts |
| Surfactant | 0.1 | parts |
| Ion exchange water | 77.4 | parts |
| Total | 100.0 | parts |

### Comparative Example 1

A comparative ink was prepared as in Examples 3 and 4 except that the pigment according to Example 1 of Patent Document 4 was used instead of the compounds according to the present invention obtained in Examples 1 and 2. Comparative Example 1 describes the preparation of this ink. The structural formula of the compound used for Comparative Example 1 is shown in the following formula (12).

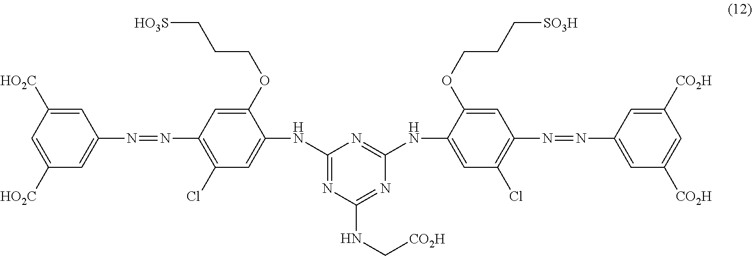 [SMILES: O=C(O)CNc1nc(Nc2cc(Cl)c(N=Nc3cc(C(=O)O)cc(C(=O)O)c3)cc2OCCCS(=O)(=O)O)nc(Nc2cc(Cl)c(N=Nc3cc(C(=O)O)cc(C(=O)O)c3)cc2OCCCS(=O)(=O)O)n1]

### [(B) Ink-Jet Recording]

Each of inks prepared in above Examples 3 and 4 and Comparative Example 1 was used to perform ink-jet recording on three types of glossy paper (ink-jet paper) for testing printing density (Dy value) and color saturation (C* value) using an ink-jet printer (Canon, Inc., Product name: PIXUS® ip4500). Upon performing ink-jet recording, image patterns were created so that reflection density can be obtained in a gradation of several steps to obtain a recorded article having a yellow gradation. The resulting recorded article was taken as a test piece, and various tests were performed thereon.

Glossy paper 1: Canon, Inc., Product name: Canon Photograph paper platinum grade (PT-101)

Glossy paper 2: Canon, Inc., Product name: Canon Photograph paper glossy gold (GL-101)

Glossy paper 3: Hewlett Packard, Product name: Advanced photograph paper

Color saturation (C* value) and printing density (Dy value) were measured at a location with the highest gradation. A colorimetric system (Product name SpectroEye® from X-Rite) was used for measurement of color saturation and printing density. Color measurements were performed under the conditions of a density standard of DIN, a wide viewing angle of 2 degrees, a light source of D65.

Methods of evaluating testing recorded images, and test results will be described below.

### [(C) Printing Density Test]

Yellow printing density (Dy value) was measured using the above colorimetric system for each test piece at a gradation part where the reflection density was highest. Results are shown in Table 8.

TABLE 8

| Dy value | Glossy paper 1 | Glossy paper 2 | Glossy paper 3 |
|---|---|---|---|
| Example 3 | 2.02 | 1.93 | 1.95 |
| Example 4 | 2.06 | 1.92 | 1.93 |
| Comparative | 1.98 | 1.75 | 1.82 |
| Example 1 | | | |

The results in Table 8 demonstrate that Examples 3 and 4 are superior to Comparative Example 1 in the yellow printing density test (Dy value) for each glossy paper. It is shown that they are particularly excellent with Glossy paper 2.

### [(D) Color Saturation Test]

Color saturation (C* value) was measured using the above colorimetric system for each test piece at a gradation part where the reflection density was the highest. Results are shown in Table 9 below.

TABLE 9

| Color saturation | Glossy paper 1 | Glossy paper 2 | Glossy paper 3 |
|---|---|---|---|
| Example 3 | 115.7 | 109.4 | 108.9 |
| Example 4 | 119.3 | 109.0 | 109.1 |
| Comparative | 109.2 | 97.4 | 99.5 |
| Example 1 | | | |

The results in Table 9 demonstrate that Examples 3 and 4 are superior to Comparative Example 1 in color saturation (C* value) for each glossy paper.

Given the above, the results reveal that the water-soluble azo compound according to the present invention and the ink composition according to the present invention containing the above compound have excellent color-developing properties attributed to the high yellow printing density, and show highly vivid hues attributed to the high color saturation as compared with the conventional pigments.

### INDUSTRIAL APPLICABILITY

The water-soluble azo compound according to the present invention as a yellow pigment, and the yellow ink composition according to the present invention containing the above compound can create recorded images with high color-developing properties (high printing density) and high color saturation. Therefore, the present compound and an ink composition containing the same are extremely useful for various recording applications, in particular for ink-jet recording applications.

1. A water-soluble azo compound represented by the following formula (1) or a salt thereof; 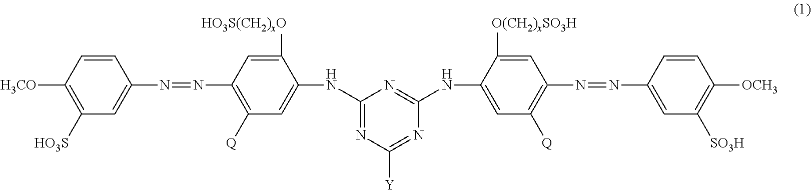
wherein in the formula (1), Q represents a halogen atom, x represents an integer of 2 to 4, and Y represents a group represented by the following formula (A) or (B): 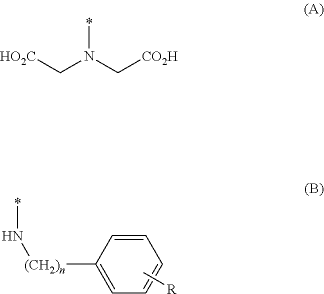
wherein in the formula (B), n represents an integer of 1 to 4, and R represents a hydrogen atom, a sulfo group or a carboxy group.

2. The water-soluble azo compound or a salt thereof according to claim 1, wherein in the formula (1), Q is a chlorine atom.

3. The water-soluble azo compound or a salt thereof according to claim 1, wherein in the formula (1), x is 3.

4. The water-soluble azo compound or a salt thereof according to claim 1, wherein in the formula (1), Q is a chlorine atom, and x is 3, and Y is a group represented by the formula (A).

5. The water-soluble azo compound or a salt thereof according to claim 1, wherein in the formula (1), Q is a chlorine atom, and x is 3, and Y is a group represented by the formula (B), and n is 1, and R is a sulfo group or a carboxy group.

6. The water-soluble azo compound or a salt thereof according to claim 1, wherein in the formula (1), Q is a chlorine atom, and x is 3, and Y is a group represented by the formula (B), and n is 1, and R is a carboxy group.

7. An ink composition comprising the water-soluble azo compound or a salt thereof according to claim 1.

8. The ink composition according to claim 7, further comprising a water-soluble organic solvent.

9. An ink-jet recording method comprising using the ink composition according to claim 7.

10. An ink-jet recording method comprising using the ink composition according to claim 7 as an ink, and discharging an ink droplet of the ink in response to a recording signal to allow attachment to a recording material, thereby performing recording.

11. The ink-jet recording method according to claim 10, wherein the recording material is an information transmission sheet.

12. The ink-jet recording method according to claim 11, wherein the information transmission sheet is regular paper or a sheet, the sheet having an ink receiving layer comprising a porous white inorganic substance.

13. A colored article colored with any one of: (a) the water-soluble azo compound or a salt thereof according to claim 1,
(b) an ink composition containing the water-soluble azo compound or a salt thereof according to claim 1, or
(c) an ink composition containing the water-soluble azo compound or a salt thereof according to claim 1 and a water-soluble organic solvent.

14. The colored article colored by the ink-jet recording method according to claim 10.

15. An ink-jet printer loaded with a container containing the ink composition according to claim 7.
